(19) United States
(12) Patent Application Publication
(10) Pub. No.: US 2006/0218047 A1
(43) Pub. Date: Sep. 28, 2006

(54) Goods distribution management system and method

(76) Inventors: Steve Mack, Las Vegas, NV (US); Marco Herrera, Las Vegas, NV (US); Kelly York, Las Vegas, NV (US); Mike Wishart, Reno, NV (US)

Correspondence Address: BERNHARD KRETEN;WEINTRAUB GENSHLEA CHEDIAK SPROULE, 400 CAPITOL MALL, 11TH FLOOR, SACRAMENTO, CA, 95814, US

(21) Appl. No.: 11/090,499

(22) Filed: Mar. 25, 2005

(51) Int. Cl. G06Q 30/00

(52) U.S. Cl. 705/26

(57) ABSTRACT

A method of distributing goods obtained from a seller through use of auction services. A store obtains goods from a seller and the goods are specifically identified and clear title to the goods is verified through a database via law enforcement agencies. The database is used to automate listing such goods in online auctions and monitoring the auctions until they conclude. if the auction concludes with a buyer, the goods are shipped and the buyer has a finite amount of time to inspect the goods and either accept them or reject them. if the buyer accepts the goods, the buyer's account is debited and the proceeds are distributed to all appropriate parties.

### FIELD OF THE INVENTION

The following invention is generally related to instrumentalities and methodologies in managing transactions involving goods. More specifically, the instant invention is directed to a system and method that streamlines the process of selling and receiving goods with as little input as possible from a seller.

### BACKGROUND OF THE INVENTION

The acquisition of items necessarily leads to the disposition of items. Items that are still functional are usually sold or given to others for further use, rather than being consigned to the trash. The traditional method for disposing of unwanted but “functional” items is the garage sale. However, holding a garage sale requires time, interest, and energy to plan and advertise the sale, to organize, clean, fix, and price goods, and to host the sale itself. A garage sale also requires hosting strangers face-to-face, being prepared for those attempting to bargain, and keeping an eye out for those who attempt to acquire, but not pay for, goods on sale.

The online auction has emerged as a modern forum for the redistribution of goods, solving some problems and creating others. The auction system allows for reduced contact between buyer and seller, eliminates the idea of “bargaining” outside the auction itself. To some degree, there still exists the problem of those who wish to receive goods without paying for them (that is, problems in collecting payment from a buyer), and contact between buyer and seller is not completely eliminated. In addition, the problem of wrapping, packing, and shipping goods, which is usually not present in a garage sale, is almost always present in the online auction system. Finally, the initial listing of items for sale on an online auction site is often too time-consuming for those who just want to rid themselves of particular goods.

Generally, businesses are under pressure to improve both top-line and bottom-line results. Businesses want to increase services to increase sales, but wish to minimize capital expenditures in providing increased sales to produce more profits.

From the auction service's point of view, the system has now settled in, but there are far more buyers than sellers participating. Surplus buyers are driving up prices, such that less value is obtained in buying auctioned goods. Sellers respond to the barriers of listing and monitoring auctions by simply not participating when the investment (of time, money, etc.) is too great, which contributes to the decrease in sellers. Of final note, a certain segment of the market is “unreachable” by auction services, perhaps because it does not have online access or the up-front costs to list, monitor, pack and ship the goods before payment is made.

### SUMMARY OF THE INVENTION

The present invention is distinguishable over the prior art in that sales may occur with minimal non-automated activity and with no direct contact between buyer and seller. Large numbers of sales may occur online with little or no further input from the store and management of those sales is similarly automated.

### OBJECTS OF THE INVENTION

Accordingly, it is a primary object of the present invention to provide a new and novel system and method for redistributing goods with minimal participation from a seller.

It is a further object of the present invention to provide a system and method as characterized above in which posting online auction offerings is virtually entirely automated, requiring little outside input.

It is a further object of the present invention to provide a system and method as characterized above which provides for confirming the presence of clear title to goods destined to be auctioned online.

It is a further object of the present invention to provide a system and method as characterized above that increases value obtained in the online auction segment of goods distribution.

Viewed from a first vantage point, it is an object of the present invention to provide A method for electronically distributing goods from a seller, the steps including:
acquiring goods from a seller;
verifying the existence of clear title to said goods via law enforcement agencies;
conducting an auction of said goods on behalf of the seller;
collecting payment from a buyer for appropriate remittance to said seller if said auction concludes with a sale;
processing said goods for delivery to said buyer if said auction concludes with a sale.

Viewed from a second vantage point, it is an object of the present invention to provide a method for redistributing goods, the steps including: acquiring goods from a party; managing an auction of said goods on behalf of said party; collecting payment from a buyer if said suction concludes with a sale to said buyer; and processing said goods for delivery to said buyer if said auction concludes with a sale, wherein said processing step includes the steps of: identifying said goods; receiving a packing recipe specific to said goods; packing said goods in a container according to said recipe; confirming that a packed container of said goods is within predetermined tolerances; and shipping said goods to said buyer.

These and other objects will be made manifest when considering the following detailed specification when taken in conjunction with the appended drawing figures.

### BRIEF DESCRIPTION OF THE DRAWINGS

FIG. 1 is a flowchart of the methodology according to the present invention.

FIG. 2 is a flowchart of the purchase process and subsequent processing.

FIG. 3 is a flowchart of post-sale shipment processing of an item.

### DESCRIPTION OF PREFERRED EMBODIMENTS

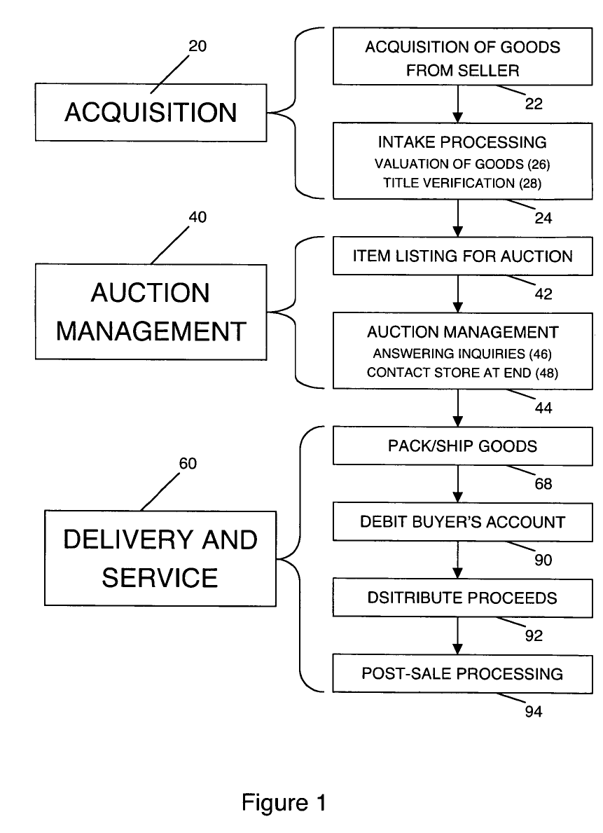

Considering the drawings, wherein like reference numerals denote like parts throughout the various drawing figures, reference numeral 10 as shown in FIG. 1 is directed to the device according to the present invention.

The flowchart of FIG. 1 shows an overview of the present system, which operates in three phases. The acquisition phase 20 comprises receipt of the physical goods 22 and related intake processing 24 by “the store”, which includes valuation 26 and title verification 28. The auction phase 40 comprises listing the goods 42 and managing the auction 44, which includes managing inquiries 46 and contacting the store at the conclusion of the auction 48. The delivery phase 60 comprises packing and shipping the goods 68, debiting the buyer's account 90, distributing the proceeds 92, and post-sale actions 94 such as returns.

The process will now be explored in detail, referring to the figures as noted.

“The store” is the entity that conducts the sale on behalf of the seller. Prior to selling goods, the store makes arrangements for goods to be dropped off. One embodiment contemplates the store to have multiple locations of its own. Another embodiment contemplates associations with other vendors to receive goods from sellers. “The store”, as used herein, refers to the store itself or its agents that receive and process goods for sale. In either case, the acquisition phase 20 begins when the seller drops the goods off 22 at a physical location.

After the goods are dropped off 22, the goods are entered into a goods database. The goods database is owned and maintained by the store, but it is also accessible to its agents. The store or its agents thus access and add goods to the database, increasing the universe of goods information generally available to the store. A value for the goods is computed using predetermined factors, such as condition, content, style, etc. The database uses internal tables to compute value. These tables may be supplemented by values obtained from online Web searching. Information from each item is verified by local law enforcement agencies to confirm that all goods has clear title.

After the goods have been accepted and processed as to value and title validity, the goods are in the auction phase 40. A description of the goods is prepared and the goods are photographed. The description and photographs are entered into the database to add success keywords to the description and to properly format the photographs for display. Submission of auction listings through use of the database is automated, requiring a single click by the store to post listings 42. Once the goods are listed, the auction listing for the goods is monitored 44 for activity. If potential buyers submit inquiries regarding the goods, the inquiries are fielded 46 by the store. The store is notified at the end of the auction 48.

If the auction concludes without a buyer, the goods may be relisted, donated to charity, or returned to the seller.

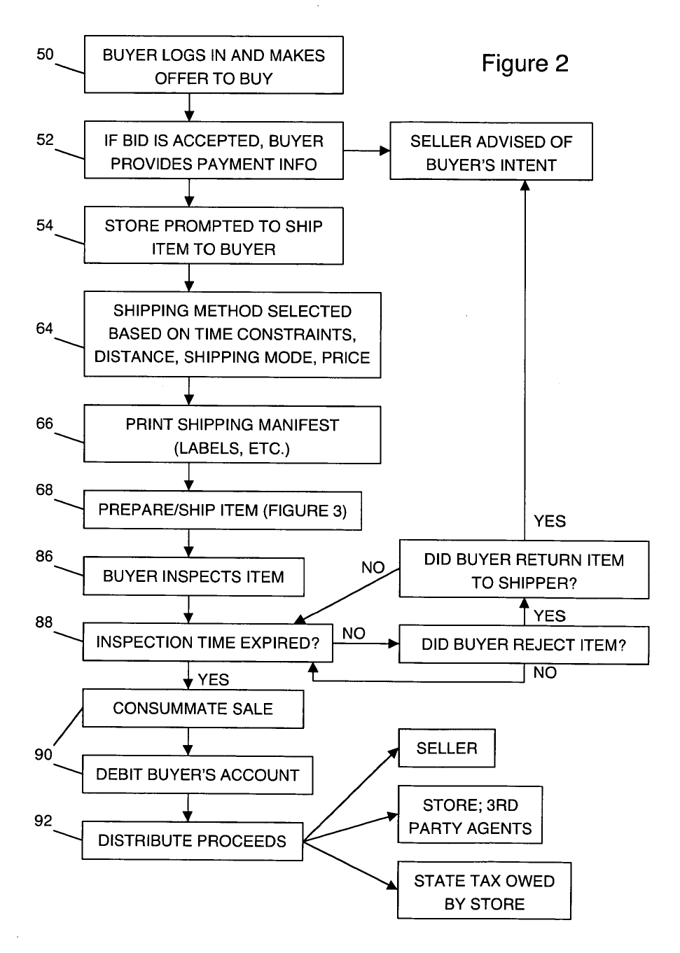

Referring to FIG. 2, a potential buyer accesses the auction site during the auction and makes an offer to purchase the goods 50. If the bid is accepted (auction's end), the buyer provides payment information to the store 62. The store is then prompted to ship the item to the buyer at the conclusion of the auction 54. The process then enters the delivery phase 60. The shipping method is chosen 64 based on several factors, including time constraints, shipping distance, shipping mode, and price. Once the method is chosen, a manifest of shipping is printed 66, which may include labels, packing lists, etc.

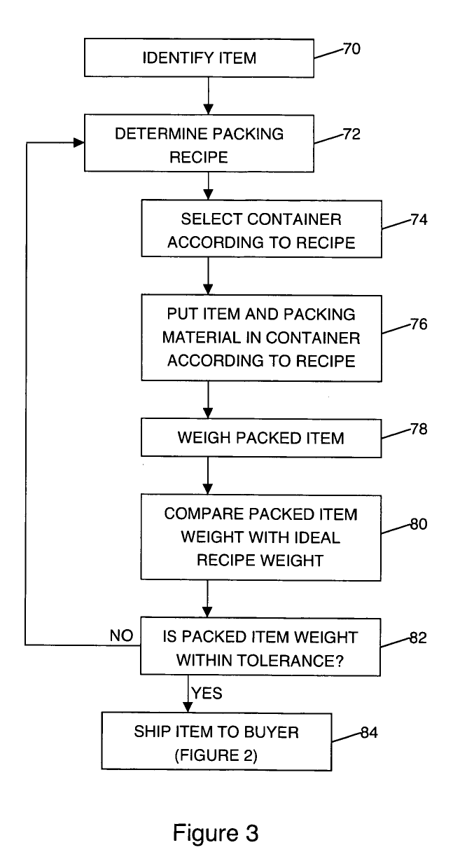

The packing process itself follows the procedure detailed in FIG. 3, beginning with identification of the goods to be packed and shipped 70. The identified goods corresponds to a particular “packing recipe”. The packing process then proceeds according to the recipe 72: a container of particular size is obtained 74; the goods and packing material are placed in the container 76; the packed goods are weighed 78 and the resulting weight is compared with the “ideal” weight for the recipe 80; if the weight of the packed goods is outside the set tolerance levels 82, the goods are repacked until it is within tolerances. The store then ships the goods to the buyer 84.

The buyer then receives and inspects the goods 86. The buyer has a fixed amount of time to decide whether or not to accept the goods 88. If the buyer rejects the goods, the buyer is instructed to return the goods to the store. The seller is notified of the return, and either (1) the next-highest bidder is contacted, (2) the goods are relisted, or (3) the goods are returned to the seller.

If the buyer accepts the goods, the sale is consummated by debiting the buyer's account 90. Once the store receives payment, the proceeds are distributed 92 between the seller, the store, and other third parties, which may include the auction providers, payment providers, credit card processing, etc.

It is of note that virtually all of the functions of the instant invention are carried out using the database referred to hereinabove, including, but not limited to: the identification and valuation of goods, the processing of information for the auction listing, the choice of shipping methods, the packing recipe, and the processing of payment.

Moreover, having thus described the invention, it should be apparent that numerous modifications and adaptations may be resorted to without departing from the scope and fair meaning of the instant invention as set forth hereinabove and as described hereinbelow by the claims.

I claim:

1- A method for electronically distributing goods from a seller, the steps including:
acquiring goods from a seller;
verifying the existence of clear title to said goods via law enforcement agencies;
conducting an auction of said goods on behalf of the seller;
collecting payment from a buyer for appropriate remittance to said seller if said auction concludes with a sale to said buyer;
processing said goods for delivery to said buyer if said auction concludes with a sale.

2- The method of claim 1 further including the step of relisting said goods in a subsequent auction if said auction concludes without a sale.

3- A method for redistributing goods, the steps including:
acquiring goods from a party;
managing an auction of said goods on behalf of said party;
collecting payment from a buyer if said suction concludes with a sale to said buyer; and
processing said goods for delivery to said buyer if said auction concludes with a sale, wherein said processing step includes the steps of:
identifying said goods;
receiving a packing recipe specific to said goods;
packing said goods in a container according to said recipe;
confirming that a packed container of said goods is within predetermined tolerances; and
shipping said goods to said buyer.
